(19) United States
(12) Patent Application Publication
(10) Pub. No.: US 2008/0208991 A1
(43) Pub. Date: Aug. 28, 2008

(54) Data Processing Arrangement

(75) Inventors: Laurent Capella, Vence (FR); Francois Caron, Golfe Juan (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/813,282

(22) PCT Filed: Dec. 15, 2005
(86) PCT No.: PCT/IB05/54265

§ 371 Date: Jul. 2, 2007

(30) Foreign Application Priority Data
Dec. 30, 2004 (EP) 04300955.4

(51) Int. Cl. G06F 15/16

(52) U.S. Cl. 709/206

(57) ABSTRACT

A data processing arrangement (BBP) comprises a system-host processor (SHP) and a system-guest processor (SGPl). The system-host processor (SHP) is provided with an operating system (OS) and an operating-system-message transceiver (SI) for receiving an operating-system-related message corresponding with a service request and for sending an operating-system-related message corresponding with a service response. The system-guest processor (SGPl) is provided with an operating-system simulator (SOI). The operating-system simulator (SOI) sends an operating-system-related message to the system-host processor (SHP) in response to a service request from a task (A, B) that the system-guest processor carries (SGP) out. The operating-system simulator (SOI) provides a service response to the task (A, H) in response to an operating-system-related message from the system-host processor (SHP).

### FIELD OF THE INVENTION

An aspect of the invention relates to a data processing arrangement that comprises an operating system. The data processing arrangement may be, for example, a baseband processor for a cellular phone. The operating system may be, for example, a so-called real-time operating system (RTOS) that provides interprocess synchronization. Other aspects of the invention relate to a method of operating a data processing arrangement, a computer program product, and a communication apparatus.

### DESCRIPTION OF PRIOR ART

International patent application published under number WO/0348965 describes a baseband chip for mobile radio systems. The baseband chip contains a controller and a digital processor. The controller uses a real-time operating system, which has a kernel. At least a portion of the functionality that is assigned to the kernel is permanently implemented on the baseband chip by means of a non-volatile memory or a hardware-status automatic device.

### SUMMARY OF THE INVENTION

According to an aspect of the invention, a data processing arrangement comprises a system-host processor and a system-guest processor. The system-host processor is provided with an operating system and an operating-system-message transceiver for receiving an operating-system-related message corresponding with a service request and for sending an operating-system-related message corresponding with a service response. The system-guest processor is provided with an operating-system simulator arranged to send an operating-system-related message to the system-host processor in response to a service request from a task that the system-guest processor carries out, and to provide a service response to the task in response to an operating-system-related message from the system-host processor.

The invention takes the following aspects into consideration. A data processing arrangement may be required to carry out various different tasks. The data processing arrangement may comprise a single processor only that carries out the various different tasks under the control of a single operating system. The operating system may provide services that, for example, relate to synchronization of the various different tasks. The aforementioned prior art is an example of this approach.

The single-processor approach lacks flexibility. The single processor has a maximum processing capacity. This puts a limit on the number of tasks that the data processing arrangement can carry out for a given average complexity of the various tasks. It is possible to provide the data processing arrangement with a more powerful single processor. However, such a processor may be relatively expensive or may not be commercially available. In the latter case, a new, more powerful processor needs to be specially designed. This takes time and is costly.

Another approach is to provide a data processing arrangement with various processors. Each processor will typically require an operating system. The data processing arrangement will generally require a relatively modest design effort if each processor uses the same operating system and if relatively many programs are available for that operating system. However, a single operating system limits the processor choice. The single operating system may exclude certain processors, which have attractive features, because these processors do not support the operating system concerned. Porting the single operating system to these processors is not a viable option because this is a time consuming and costly process.

The data processing arrangement may be arranged so that one processor operates under one operating system and another processor under another operating system. In that case, the processor choice is vast. However, such a data processing arrangement will require relatively much design effort. It will be difficult to make the processors, which operate under different operating systems, work together in an appropriate manner. Complicated schemes will generally be required to achieve interprocess synchronization. Debugging will be difficult. Moreover, software may not be interchangeable: a program code for one processor, which defines one or more tasks, cannot be used on the other processor, and vice versa.

In accordance with the aforementioned aspect of the invention, a system-host processor is provided with an operating system and an operating-system-message transceiver, and a system-guest processor is provided with an operating-system simulator. The operating-system simulator communicates with the operating system by means of operating-system-related messages that transit via the operating-system-message transceiver.

Accordingly, the operating-system simulator can provide operating-system services to a task that the system-guest processor carries out, although the system-guest processor has no real operating system. Consequently, software on the system-guest processor operates under the control of the operating system, which is on the system-host processor, as if the operating system were present on the system-guest processor. There is no need to port the operating system on the system-guest processor, which is a time consuming and costly process as mentioned hereinbefore. It is sufficient to provide the system-guest processor with the operating-system simulator, which generally requires a modest design effort only. Accordingly, invention allows a vast choice of different processors without this requiring relatively much design effort. For those reasons, the invention allows relatively great flexibility and, as a result, a relatively short time-to-market when a demand for new features occurs.

Another advantage of the invention relates to the following aspects. Software that is compatible with the operating system of the system-host processor can be used on any system-guest processor. Software, in the form of program codes, can easily be interchanged because the operating-system simulator accounts for any operational differences between system-guest processors. Consequently, software can be developed relatively easily and can be re-used. Moreover, debugging will be relatively simple. For those reasons, the invention allows cost-efficiency.

These and other aspects of the invention will be described in greater detail hereinafter with reference to drawings.

### BRIEF DESCRIPTION OF THE DRAWINGS

FIG. 1 is a block diagram that illustrates a cellular phone.

FIG. 2 is a block diagram that illustrates a baseband processor of the cellular phone.

FIG. 3 is a conceptual diagram that illustrates an operating-system simulator in the baseband processor.

FIG. 4 is a conceptual diagram that illustrates an operating-system-message transceiver in the baseband processor.

FIG. 5 is a table that illustrates priorities in the operating-system-message transceiver.

FIG. 6 is a conceptual diagram that illustrates two service requests for interprocess synchronization by means of semaphores.

FIG. 7 illustrates interprocess synchronization in the baseband processor.

### DETAILED DESCRIPTION

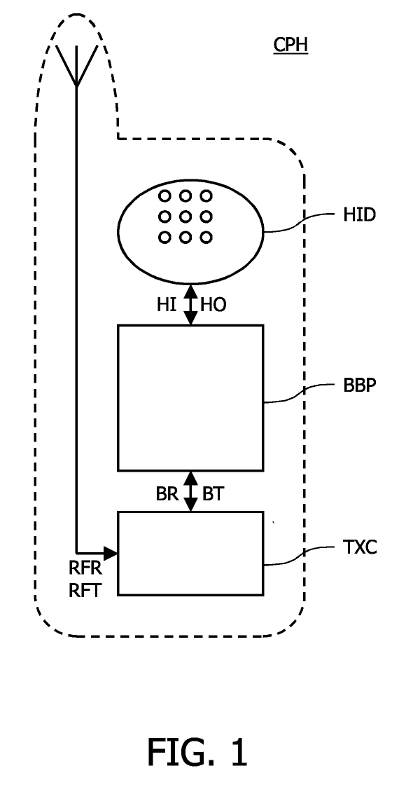

FIG. 1 illustrates a cellular phone CPH. The cellular phone CPH comprises a transmitter-and-receiver circuit TXC, a baseband processor BBP, and human interface devices HID. The human interface devices HID may comprise, for example, a small loudspeaker, a small microphone, a display device, and a numerical keyboard for dialing a number.

In a reception mode, the transmitter-and-receiver circuit TXC provides a received baseband signal BR in response to a received radio frequency signal RFR. The baseband processor BBP processes the received baseband signal BR, which may comprise data from a calling party or data from a base station or another cellular phone network entity, or any combination of such data. The processing of the received baseband signal BR results in a human-interface input signal HI. For example, the baseband processor BBP may derive from the received baseband signal BR an audio signal for the small loudspeaker.

In a transmission mode, there is an opposite signal flow, which starts with a human-interface output signal HO. For example, the baseband processor BBP processes an audio signal that the small microphone provides in response to spoken word. The processing results in a transmission baseband signal BT, which the baseband processor BBP applies to the transmitter-and-receiver circuit TXC. In response, the transmission and receiver circuit emits a transmission radiofrequency signal RFT, which comprises the transmission baseband signal BT.

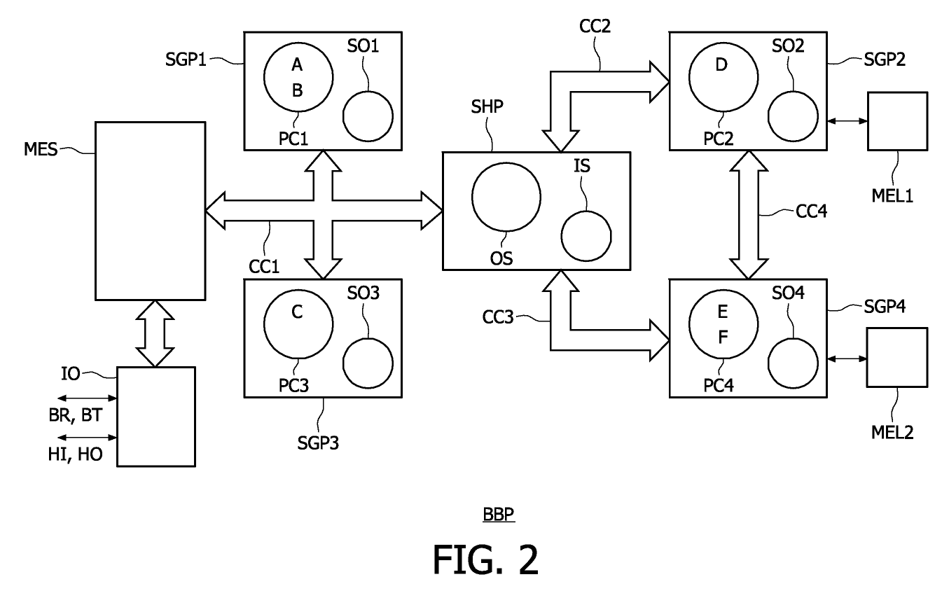

FIG. 2 illustrates the baseband processor BBP. The baseband processor BBP comprises a system-host processor SHP, four system-guest processors SGP1-SGP4, a shared memory MES, two local memories MEL1, MEL2, and an input-output circuit 10 for reception and transmission of baseband signals BR, BT and human-interface signals HI, HO. The baseband processor BBP further comprises four communication channels CC1-CC4 via which the aforementioned processors may communicate with each other.

The system-host processor SHP and four system-guest processors SGP1-SGP4 may each be different from the other processors. Each processor may be in the form of an individual integrated circuit, such as, for example, a digital signal processor or another type of dedicated processor, or a general purpose processor. The baseband processor BBP, which is illustrated in FIG. 2, can thus be implemented as a printed circuit board with various different types of commercially available processors that need to closely cooperate. The baseband processor BBP may also be implemented as a so-called system-on-chip, which is based on existing integrated-circuit designs for the various processors. A composition of these existing integrated-circuit designs is made. This allows a relatively fast design because relatively few additional circuitry is required.

The system-host processor SHP comprises an operating system OS and an operating-system-message transceiver IS. Each system-guest processor SGP comprises a program code PC and an operating-system simulator SO. Program code PC1 defines two tasks that system-guest processor SGP1 carries out: task A and task B. Program code PC2 defines task D that system-guest processor SGP2 carries out. Program code PC3 defines task C that system-guest processor SGP3 carries out. Program code PC4 defines two tasks that system-guest processor SGP4 carries out: task E and task F.

The operating system OS is a generic software program that provides services to other software programs. Program codes PC1-PC4 can use the services that the operating system OS provides via operating-system simulators SO1-S04, respectively, and the operating-system-message transceiver IS. Program code PC1 can be written as if the operating system OS were running on system-guest processor SGP1 where program code PCd resides and is executed. The same applies to program codes PC2, PC3, and PC4, and system-guest processors SGP2, SGP3, and SGP4, respectively.

Each program code PC can generate service requests for the operating system OS and can handle service responses from the operating system OS. A service request may relate to an existing data object within the baseband processor BBP or to a program that previously has been started, which is either being executed or in a suspended state. However, a service requests may also relate to a data object that needs to be created or a program that needs to be started. Such a service request will be referred to hereinafter as initial service request, wherever appropriate.

FIG. 3 illustrates operating-system simulator SO1. Operating-system simulator provides various functions: a send-message-to-host function SNDH, a receive-message-from-host function RECH, a switch context function SWC, and a service-transparency function SERV. The other operating-system simulators SO2, SO2, and S04, provide similar functions and operate in a like manner.

FIG. 3 illustrates that operating-system simulator SO1, which resides in system-guest processor SGP1, can send messages MSG to the operating-system-message transceiver IS, which resides in the system-host processor SHP. The operating-system simulator SO1 can also receive messages MSG from the operating-system-message transceiver IS. There are numerous different mechanisms that can be used to transfer these messages from operating-system simulator SO1 to the operating-system-message transceiver IS, or vice versa. Interrupts, control registers with shared variables, mailboxes, and memory sharing are some examples.

The service-transparency function SERV provides a message in response to a service request, which is intended for the operating system OS. The send-message-to-host function SNDH sends this message, which corresponds with the service request, to the system-host processor SHP. Conversely, the receive-message-from-host function RECH reads a message that system-guest processor SGP1 has received from the system-host processor SHP. The service-transparency function SERV decodes this message, which concerns a service response from the operating system OS. Accordingly, the service-transparency function SERV provides the service response as if the operating system OS were running on system-guest processor SGP1. The service response may be, for example, an instruction to switch from one task to another.

The switch-context function SWC carries out various operations that are required to appropriately switch from one task to another. Let it be assumed that system-guest processor SGP1 needs to switch from task A to task B. At the instant when the task switch needs to commence, registers within system-guest processor SGP1 contain certain data. This data, which may comprise various parameters and intermediate processing results, forms a context of task A. The switch-context function SWC saves the data that forms the context of task A in, for example, a dedicated stack area. This allows system-guest processor SGP1 to resume task A at a later stage.

Let it be assumed that task B has previously been stopped and that its context has been saved as described hereinbefore with respect to task A. The switch-context function SWC retrieves the data that forms the context of task B from the dedicated stack area and loads this data into the relevant registers. Subsequently, the switch-context function SWC allows system-guest processor SGP1 to resume execution of task B.

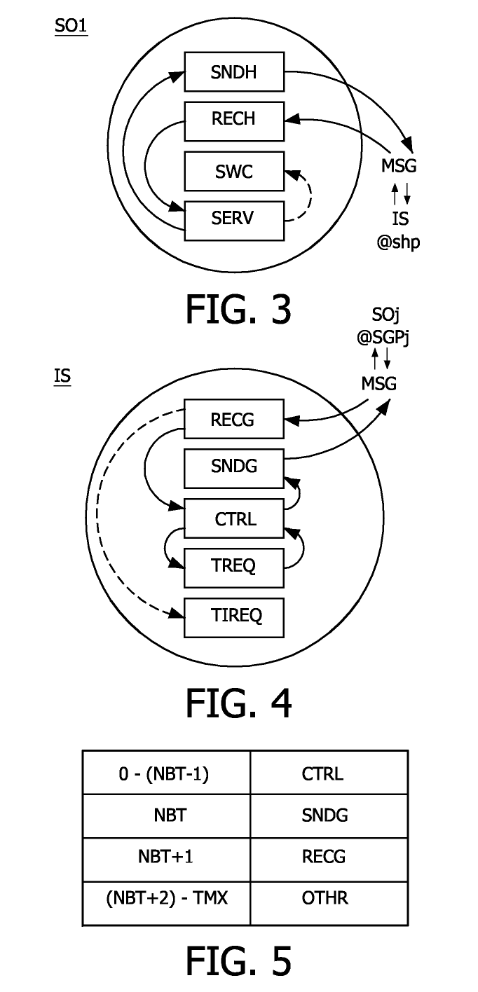

FIG. 4 illustrates the operating-system-message transceiver IS. The operating-system-message transceiver IS provides various functions: a receive-message-from-guest function RECG, a send-message-to-guest function SNDG, a control function CTRL, a treat-request function TREQ, and a treat-initial-request function TIREQ. The control function CTRL comprises a control sub-function for each task that is running on the baseband processor BBP. FIG. 4 illustrates, in a manner similar to FIG. 3, that the operating-system-message transceiver IS, which resides in the system-host processor SHP, can exchange messages MSG with the respective operating-system simulators SOj in the respective system-guest processors SGPj, with “j” being 1, 2, 3, or 4.

The receive-message-from-guest function RECG waits for a message from a system-guest processor and decodes the message when one has arrived. Accordingly, the service request from the system-guest processor, which has sent the message, is obtained.

Let it be assumed that the service request is an ordinary service request, not an initial service request. In that case, the receive-message-from-guest function RECG passes the service request to the relevant control sub-function of the control function CTRL. The control sub-function invokes the treat-request function TREQ, which causes the operating system OS to act on the service request, that is, to provide a service response. The control sub-function subsequently waits until it has sufficient priority so as to invoke the send-message-to-guest function SNDG. The send-message-to-guest function SNDG provides a message on the basis of the service response and sends that message to the system-guest processor from which the service request originated.

Let it now be assumed that the service request is an initial service requests. In that case, the receive-message-from-guest function RECG invokes the treat-initial-request function TIREQ. In response, the treat-initial-request function TIREQ causes the operating system OS to act on the service request. The operating system OS may, for example, create a data object, or start a new program, or create a task.

FIG. 5 illustrates a priority setting for the various functions that the operating-system-message transceiver IS provides. FIG. 5 is a table with a left column and a right column. The left column indicates a priority order by means of a value. The lower value is, the higher the priority is; 0 is the highest priority. A number-of-tasks parameter NBT and a maximum-number-of-tasks parameter TMX appear in the left-hand column. The number-of-tasks parameter NBT has a value equal to the number of tasks that are running on the four system-guest processors SGP1-SGP4. The maximum-number-of-tasks parameter TMX has a value equal to the maximum number of tasks that the system-host processor SHP may manage.

The various functions that the operating-system-message transceiver IS provides appear in the right hand column. The control function CTRL has a higher priority than the send-message-to-guest function SNDG, which has a higher priority than the receive-message-from-guest function RECG. All other functions OTHR have a lower priority. Such functions may include, for example, proprietary tasks that run on the system-host processor SHP.

The services that the operating system OS provides include interprocess synchronization by means of semaphores. A semaphore is a data object that is associated with a particular resource within the baseband processor BBP, such as, for example, the shared memory MES. A semaphore handles access to the resource with which is associated.

A semaphore typically comprises a variable having an integer value. The integer value indicates a status of the resource, which can be locked or available. A requester can have no access if the integer value indicates that the resource is locked because one or more other requesters have already been granted access. A requester may access the resource if the integer value indicates that the resource is available. Any of the tasks A-F, which are illustrated in FIG. 2, may be a requester that desires to access a resource, which is protected by means of a semaphore.

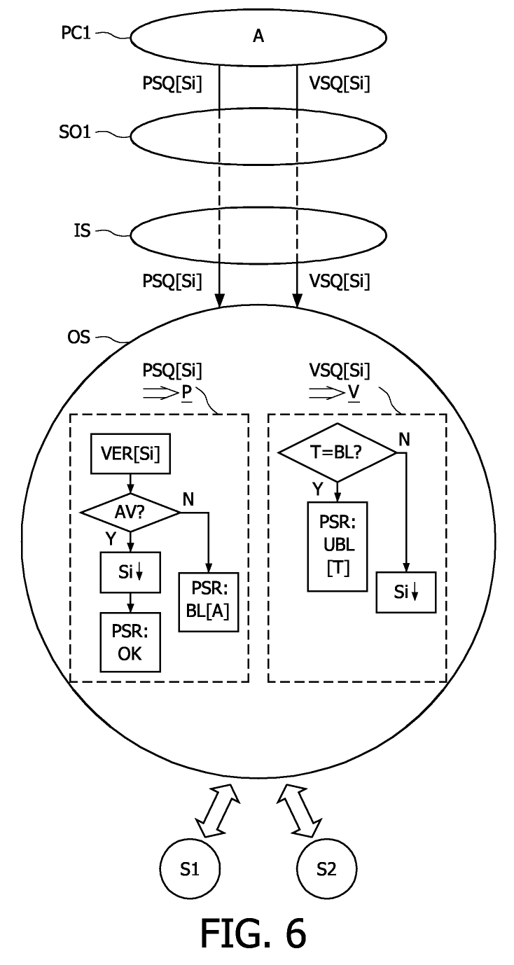

FIG. 6 illustrates two service requests for interprocess synchronization by means of semaphores. FIG. 6 illustrates a wait-function service request PSQ[Si] and a signal function service request VSQ[Si]. The aforementioned service requests relate to a particular semaphore Si, with “i” being an index that indicates the semaphore concerned. FIG. 6 has a bottom section that illustrates two semaphores S1, S2, which implies that i=1 or i=2 can apply.

FIG. 6 illustrates a case in which the wait-function service request PSQ[Si] and the signal function service request VSQ[Si] come from task A, which is defined in program code PC1 as illustrated in FIG. 2. However, each program code PC illustrated in FIG. 2 may define wait-function service requests and signal function service requests. Consequently, any of the tasks, which are illustrated in FIG. 2, may have a wait-function service request PSQ[Si] or a signal function service request VSQ[Si] at a particular instant. These requests are processed in a manner similar to the manner that will be described hereinafter with reference to task A.

Operating-system simulator SO1 sends a message to the system-host processor SHP in response to the wait-function service request PSQ[Si] from task A. The operating-system-message transceiver IS, which handles this message, presents the wait-function service request PSQ[Si] to the operating system OS. In response, operating system OS carries out a wait function P with respect to the semaphore concerned. The same mechanism applies to the signal function service request VSQ[Si], in which case the operating system OS carries out a signal function V with respect to the semaphore concerned.

FIG. 6 illustrates the wait function P, which the operating system OS carries out in response to the wait-function service request PSQ[Si] from task A. The operating system OS verifies the status of the semaphore concerned (VER[Si]). The resource with which the semaphore is associated may be available or locked. In either case, the operating system OS provides a wait-function service response PSR that corresponds with the status of the semaphore. The operating-system-message transceiver IS sends a message to system-guest processor SGP1, which was carrying out task A. Operating-system simulator SO on system-guest processor SGP1 receives this message, which corresponds with the wait-function service response PSR. Operating-system simulator SO acts accordingly, as if operating-system simulator SO were a true operating system locally running on system-guest processor SGP1.

Let it be assumed that the semaphore concerned indicates that the resource is available (AV?=Y). In that case, the operating system OS decreases the integer value of the semaphore by one unit (Si←). This may cause the semaphore to indicate hereinafter that the resource is locked. Operating-system simulator SO1 allows task A to continue (PSR: OK).

Let it now be assumed that the semaphore indicates that the resource is locked. Task A cannot access the resource. The operating system OS registers that task A will be blocked on the semaphore concerned, as it were. Operating-system simulator SO1 on system-guest processor SGP1 prevents task A from continuing (PSR:BL[A]). Operating-system simulator SO1 may cause system-guest processor SGP1 to switch to task B.

FIG. 6 also illustrates the signal function V, which the operating system OS carries out in response to the signal-function service request VSQ[Si]. The operating system OS checks whether there are any tasks that are blocked on the semaphore concerned (T=BL?). If so (Y), the operating system OS unblocks the task that is blocked (PSR: UBL[T]). To that end, the operating-system-message transceiver IS sends a message to the system-guest processor that has previously been carrying out the task concerned. The operating-system simulator on the system-guest processor concerned receives this message. The operating-system simulator acts accordingly, as if the operating-system simulator were a true operating system locally running on the system-guest processor concerned. For example, the operating-system simulator may immediately switch from a current task to the task that has been unblocked. This is a preemptive mode of operation. The operating-system simulator may also allow the current task to continue and wait until this task has finished before resuming the task that has been unblocked. This is a non-preemptive mode of operation.

The operating system OS increments the integer value of the semaphore by one unit (Si↑) if there are no tasks that are blocked on the semaphore (T=BL?=N). This may cause the semaphore to indicate hereinafter that the resource is available.

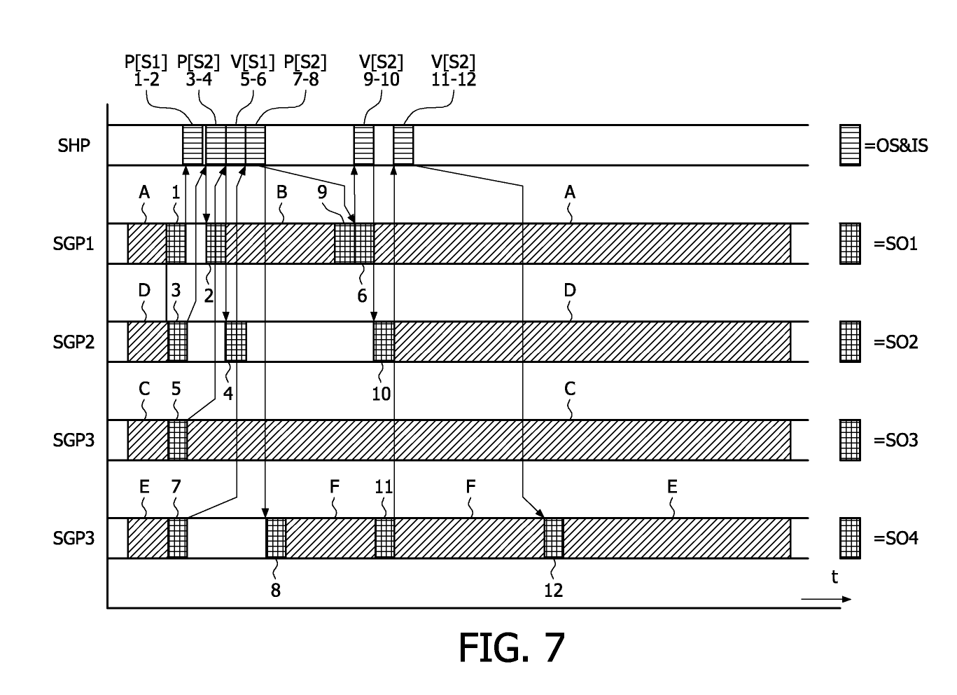

FIG. 7 illustrates interprocess synchronization in the baseband processor BBP illustrated in FIG. 2. FIG. 7 is a graph that has a horizontal axis that represents time. The system-host processor SHP and the four system-guest processors SGP1-SGP4 appear on a vertical axis. FIG. 7 comprises a bar for each processor. The bar indicates tasks or functions that the relevant processor in carries out. In FIG. 7, reference numerals indicate service requests and service responses. Reference numerals that have an odd value indicate service requests. Reference numerals that have an even value indicate service responses. It is assumed that each of the two semaphores S1, S2, which are illustrated in FIG. 6, initially indicate that the relevant resource is not available. It is further assumed that each system-guest processor SGP operates in a non-preemptive mode.

System-guest processor SGP1 initially carries out task A. Task A needs to access the resource that semaphore S1 handles. Consequently, task A presents a wait-function service request 1 to operating-system simulator SO1 of system-guest processor SGP1. Operating-system simulator SO1 suspends task A and causes the wait-function service request 1 to appear at the operating system OS on the system-host processor SHP. The operating system OS carries out a wait function P with respect to semaphore S1. Subsequently, the operating system OS causes operating-system simulator SO1 to carry out a wait-function service response 2. Since the resource that semaphore S1 handles is not available, operating-system simulator SO1 causes system-guest processor SGP1 to switch from task A to task B. Task A is now blocked on semaphore S1.

System-guest processor SGP2 initially carries out task D. Task D needs to access the resource that semaphore S2 handles. Consequently, task D presents a wait-function service request 3 to operating-system simulator SO2 of system-guest processor SGP1. Operating-system simulator SO2 suspends task D and causes the wait-function service request 3 to appear at the operating system OS on the system-host processor SHP. The operating system OS carries out a wait function P with respect to semaphore S2. Subsequently, the operating system OS causes operating-system simulator SO2 to carry out a wait-function service response 4. Since the resource that semaphore S2 handles is not available, operating-system simulator SO2 prevents system-guest processor SGP2 from continuing D. Task D is blocked on semaphore S2.

System-guest processor SGP3 initially carries out task C. Task C has been accessing the resource that semaphore S1 handles, but no longer requires that resource. Consequently, task C presents a signal-function service request 5 to operating-system simulator SO3 of system-guest processor SGP3. Operating-system simulator SO3 does not suspend task C in the case of a signal-function service request. Operating-system simulator SO3 causes the signal-function service request 5 to appear at the operating system OS on the system-host processor SHP. The operating system OS carries out a signal function V with respect to semaphore S1. The operating system OS establishes that task A is blocked on semaphore S1 and decides to unblock task A, which system-guest processor SGP1 has previously been carrying out. As a result, the operating system OS causes operating-system simulator SO1 on system-guest processor SGP1 to carry out a signal-function service response 6. Operating-system simulator SO1 does not immediately switch back from task B to task A. This is because system-guest processor SGP1 operates in a non-preemptive mode. Operating-system simulator SO1 allows system-guest processor SGP1 to resume task A, which has previously been blocked on semaphore S1, when task B has finished.

System-guest processor SGP2 initially carries out task E. Task E needs to access the resource that semaphore S2 handles. Consequently, task E presents a wait-function service request 7 to operating-system simulator S04 of system-guest processor SGP4. Operating-system simulator S04 suspends task E and causes the wait-function service request 7 to appear at the operating system OS on the system-host processor SHP. The operating system OS carries out a wait function P with respect to semaphore S2. Subsequently, the operating system OS causes operating-system simulator S04 to carry out a wait-function service response 8. Since the resource that semaphore S2 handles is not available, operating-system simulator S04 causes system-guest processor SGP4 to switch from task E to task F. Task E is now blocked on semaphore S2.

Task B presents a signal-function service request 9 with respect to semaphore S2 when task B has finished. Task B no longer requires the resource that the semaphore S2 handles. Operating-system simulator SO1 causes the signal-function service request 9 to appear at the operating system OS on the system-host processor SHP. The operating system OS carries out a signal function V with respect to semaphore S2. The operating system OS establishes that task D is blocked on semaphore S1 and decides to unblock task D, which system-guest processor SGP2 has previously been carrying out. As a result, the operating system OS causes operating-system simulator SO2 on system-guest processor SGP2 to carry out a signal-function service response 10. Operating-system simulator SO2 allows system-guest processor SGP2 to resume task D, which has previously been blocked on semaphore S2.

Task F presents a signal-function service request 11 with respect to semaphore S2 during the execution of task F has finished. Operating-system simulator S04 causes the signal-function service request 11 to appear at the operating system OS on the system-host processor SHP. The operating system OS carries out a signal function V with respect to semaphore S2. The operating system OS establishes that task E is blocked on semaphore S2 and decides to unblock task E, which the same system-guest processor SGP4 has previously been carrying out. As a result, the operating system OS causes operating-system simulator S04 to carry out a signal-function service response 12. Operating-system simulator SO1 does not immediately switch back from task F to task E, because system-guest processor SGP4 operates in a non-preemptive mode. Operating-system simulator S04 allows system-guest processor SGP1 to resume task E, which has previously been blocked on semaphore S2, when task F has finished.

### Concluding Remarks

The detailed description hereinbefore with reference to the drawings illustrates the following characteristics, which are cited in claim 1. A data processing arrangement (BBP) comprises a system-host processor (SHP) and a system-guest processor (SGP1). The system-host processor is provided with an operating system (OS) and an operating-system-message transceiver (S1) for receiving an operating-system-related message (MSG) corresponding with a service request and for sending an operating-system-related message corresponding with a service response. The system-guest processor is provided with an operating-system simulator (SO1). The operating-system simulator sends an operating-system-related message to the system-host processor in response to a service request (PSQ, VSQ) from a task (A, B) that the system-guest processor carries out, The operating-system simulator provides a service response (PSR) to the task in response to an operating-system-related message from the system-host processor.

The detailed description hereinbefore further illustrates the following optional characteristics, which are cited in claim 2. The data processing arrangement comprises a plurality of system-guest processors (SGP1, SGP2, SGP3, SGP4). The operating system (OS) provides interprocess synchronization (1-12) between various tasks (A-F) that the plurality of system-guest processors have been programmed to carry out. These characteristics allow efficient interprocess synchronization.

The detailed description hereinbefore further illustrates the following optional characteristics, which are cited in claim 3. The operating system (OS) provides interprocess synchronization on the basis of semaphores (S1, S2). The respective operating-system simulators (SO1, SO2, SO3, SO4) cause the operating system to carry out a wait function (P) and a signal function (V) in response to a wait-function service request (PSQ) and a signal-function service request (VSQ), respectively. These characteristics further contribute to an efficient interprocess synchronization.

The detailed description hereinbefore further illustrates the following optional characteristics, which are cited in claim 4. The operating-system simulator (SO1) can make the system-guest processor (SGP1) switch (SWC) to another task (from A to B, or vice versa) in response to the operating-system-related message (MSG) from the system-host processor (SHP). These characteristics further contribute to efficient interprocess synchronization.

The aforementioned characteristics can be implemented in numerous different manners. In order to illustrate this, some alternatives are briefly indicated.

The operating-system simulator may provide any service that an operating-system typically provides. Services need not necessarily concern interprocess synchronization. For example, certain operating systems provide file-management services. Let it be assumed that the system-host processor is provided which such an operating system. In that case, a program code on a system-guest processor can use file-management services via the operating-system simulator, which resides in the system-guest processor, and the operating-system-related message transceiver, which resides on the host processor. Such file-management services may allow the system-guest processor to access, for example, a local hard disk or other data storage medium, which may be included in a network file system.

Although interprocess-synchronization services based on semaphores are advantageous, other interprocess-synchronization techniques may be applied. For example, interprocess-synchronization services may be based on a monitor concept or a message-passing concept.

The system-host processor may be formed by a subsystem that comprises a plurality of processors. In such an implementation, the operating system may be, for example, a so-called distributed operating system, in which operating-system tasks are distributed among various processors. A system-guest processor may also be formed by a subsystem that comprises a plurality of processors. In such a subsystem, there may be one subsystem-host processor that directly receives services from the system-host processor by means of operating-system-related messages, which these processor exchange. This subsystem-host processor behaves as if an operating system were running on that processor. The other processors of the subsystem, which are the subsystem-guest processors, receive services from the subsystem-host processor that, in its turn, receives those services from the system-host processor. In such an implementation, there is thus a hierarchy of different systems. Each hierarchy level can be associated with a system as shown in FIG. 2.

The system-host processor may carry out tasks in addition to providing operating-system services. For example, let it be assumed that in the baseband processor BBP illustrated in FIG. 2, the four system-guest processors SGP1, SGP2, SGP3, SGP4 carry out video and audio processing tasks. These tasks are time-critical. Simultaneously, the system-host processor SHP may carry out one or more tasks that are related to a wireless infrared communication between the cellular phone CHP and another apparatus. These tasks are less time-critical.

The system-host processor may be hardware-based rather than software-based. For example, the system-host processor may be in the form of a dedicated integrated circuit (ASIC) that comprises a real-time hardware unit (RTU) and an appropriate communication interface. Hardware-based implementations generally have a higher processing speed but are less flexible than software-based implementations. Likewise, a system-guest processor may equally be hardware-based rather than software-based.

There are numerous different applications for the invention. A cellular phone is merely an example. The invention may be applied in, for example, a base station or in the field of aeronautics. The invention is particularly suited for applications that require real-time management of various resources within a system.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A data processing arrangement comprising:
a system-host processor that is provided with an operating system and an operating-system-message transceiver for receiving an operating-system-related message corresponding with a service request and for sending an operating-system-related message corresponding with a service response;
a system-guest processor that is provided with an operating-system simulator arranged to send an operating-system-related message to the system-host processor in response to a service request from a task that the system-guest processor carries out, and to provide a service response to the task in response to an operating-system-related message from the system-host processor.

2. A data processing arrangement as claimed in claim 1, wherein the data processing arrangement comprises a plurality of system-guest processors the operating system being arranged to provide interprocess synchronization between various tasks that the plurality of system-guest processors have been programmed to carry out.

3. A data processing arrangement as claimed in claim 2, wherein the operating system is arranged to provide interprocess synchronization on the basis of semaphores, the respective operating-system simulator being arranged to cause the operating system to carry out a wait function and a signal function in response to a wait-function service request and a signal-function service request, respectively.

4. A data processing arrangement as claimed in claim 1, wherein the operating-system simulator is arranged to make the system-guest processor switch to another task, in response to the operating-system-related message from the system-host processor.

5. A data processing arrangement as claimed in claim 1, wherein the system-host processor is in the form of an integrated circuit device and wherein the system-guest processor is in the form of another integrated circuit device.

6. A method of operating a data processing arrangement that comprises a system-host processor and a system-guest processor, the method comprising:
an operating system simulation step in which the system-guest processor sends an operating-system-related message to the system-host processor in response to a service request from a task E that the system-guest processor carries out; and
an operating system message reception step in which the system-host processor causes the operating system to provide a service in response to the operating-system-related message from the system-guest processor.

7. A method as claimed in claim 6, wherein the service comprises a service response for the system-guest processor, the method comprising:
an operating system message transmission step in which the system-host processor sends an operating-system-related message to the system-guest processor, the operating-system-related message corresponding with the service response; and
a complementary operating system simulation step in which the system-guest processor acts in accordance with the service response in response to the operating-system-related message received from the system-host processor.

8. A computer program product for a data processing arrangement that comprises a system-host processor and a system-guest processor, the computer program product comprising an operating-system simulator in the form of a set of instructions that, when loaded into the system-guest processor, causes the system-guest processor to carry out:
an operating system simulation step in which the system-guest processor sends an operating-system-related message to the system-host processor in response to a service request from a task that the system-guest processor carries out, the operating-system-related message causing an operating system on the system-host processor to provide a service for the task that are the system-guest processor carries out.

9. A computer program product as claimed in claim 8, wherein the operating-system simulator further causes the system-guest processor to carry out:
a complementary operating system simulation step in which the system-guest processor acts in accordance with a service response in response to an operating-system-related message received from the system-host processor.

10. A computer program product for a data processing arrangement that comprises a system-host processor and a system-guest processor, the computer program product comprising an operating-system-message transceiver in the form of a set of instructions that, when loaded into the system-host processor, causes the system-host processor to carry out:
an operating system message reception step in which the system-host processor causes an operating system on the system-host processor to provide a service in response to an operating-system-related message from the system-guest processor.

11. A computer program product as claimed in claim 10, wherein the operating-system-message transceiver further causes the system-host processor to carry out:
an operating system message transmission step in which the system-host processor sends an operating-system-related message to the system-guest processor, the operating-system-related message corresponding with a service response.

12. A communication apparatus comprising a data processing arrangement as claimed in claim 1, and a human interface device that is functionally coupled to the data processing arrangement.
